(19) United States
(12) Patent Application Publication
(10) Pub. No.: US 2016/0231439 A1
(43) Pub. Date: Aug. 11, 2016

(54) DEVICE AND METHOD FOR DETECTION OF RADIOACTIVE RADIATION

(71) Applicant: Thermo Fisher Scientific Messtechnik GmbH, Erlangen (DE)

(72) Inventors: Norbert TROST, Erlangen (DE); Erich LEDER, Heroldsbach (DE)

(21) Appl. No.: 15/015,929

(22) Filed: Feb. 4, 2016

(30) Foreign Application Priority Data
Feb. 6, 2015 (DE) 10 2015 101 764.4
Feb. 6, 2015 (DE) 20 2015 100 590.3

(51) Int. Cl. G01T 1/20

(52) U.S. Cl. CPC G01T 1/20

(57) ABSTRACT

A device for detection of radioactive radiation having at least one detector element. The at least one detector element comprises a scintillator made of material transmissive for photons emitted by the scintillator, which comprises a first surface and a second surface opposite to the first surface, which extends respectively from a first side surface of the scintillator to a second side surface of the scintillator opposite to the first side surface. A support made of a material transmissive for photons emitted by the scintillator, which comprises a first surface and a second surface opposite to the first surface, which extends respectively from a first side surface of the support to a second side surface of the support opposite to the first side surface, wherein the first surface of the support is optically connected with the first surface of the scintillator. At least one light sensor, which is disposed on an inner side surface of the detector element and is optically connected with the first side surface of the scintillator and/or the first side surface of the support. A method for detection of radioactive radiation with a type of device, by which photons emitted by the scintillator are conducted by the support and/or scintillator to the light sensor and are converted into a signal.

The invention relates to a device and a method to detect radioactive radiation, which is used, for example, during contamination measurement in contamination monitors in nuclear facilities.

It is known, for example, to use detector elements with an approximately 0.25 to 1 mm thick film made of a scintillating material to measure radioactive contamination. The photons generated by the radioactive radiation from the scintillator are detected with a light sensor arranged on the back of the scintillator, usually a photomultiplier tube, and are converted into an electrical signal. In known focusing methods, the photons should be aimed into the light sensor, but often high losses occur, since the light escapes from the detector element to a great extent to other positions.

Another method for measuring radioactive contaminations with use of thin scintillation films is described in DE 10 2005 017 557 B4. A wavelength-shifting, light-guiding fiber is applied spirally on the back of the scintillator, both ends of which are fed into a photosensor and/or an analysis unit. Thereby, however, only a small proportion of the photons emitted by the scintillator are transmitted, so that a coincidence circuit is required to maintain an acceptable signal-noise ratio.

It is also known to arrange wavelength-shifting fibers on the edges of a scintillator film, in order to guide the light into the light sensor and/or collect it therein, wherein due to high losses, however, during the transmission of the photons in the direction of the fiber, only unsatisfactory results can be achieved.

The device for detecting radioactive contamination disclosed in DE 102 08 960 B4 comprises a light conductor in the form of a flat plate with detection elements arranged respectively on the flat sides, in order to be able to perform a simultaneous measurement of two objects, for example two hand palms. The scintillation radiation from the light conductor is detected with an optoelectronic counter. Thereby, the scintillator has a smaller refractive index than the light conductor, to prevent reflections to a great extent when the light enters into the light conductor.

The object of the invention is to specify a device and a method, with which radioactive radiation can be reliably and economically detected.

The former object is accomplished with a device having the features of claim 1. The device for detection of radioactive radiation comprises at least a detector element, which includes a scintillator, a support and at least one light sensor. The scintillator consists of material which is transmissive for photons emitted or generated by the scintillator and comprises a first surface and a second surface opposite to the first surface, which extends respectively from a first side surface of the scintillator to a second side surface of the scintillator opposite to the first side surface. The support likewise consists of a material transmissive for photons emitted or generated by the scintillator and comprises a first surface and a second surface opposite to the first surface, which extend respectively from a first side surface of the support to a second side surface of the support facing opposite to the first side surface. The first surface of the support is optically connected with the first surface of the scintillator. The at least one light sensor of the detector element is disposed on a side surface of the detector element and is optically connected with the first side surface of the scintillator and/or the first side surface of the support.

The term transmissive or transparent material is to be understood to the effect, that both the support and the scintillator consist of a material which easily conducts the wavelength of the photons generated by the scintillator or emitted therefrom. In other words: The optical attenuation within the scintillator and the support is minor. The scintillator and the support typically have an attenuation length of more than 1 m. Attenuation length is a well understood term in optics and refers to the length over which intensity has dropped to 1/e. As a result, the number of photons which are conducted through the scintillator or support is increased, thus improving the measuring signal.

The device comprises at least a detector element having a scintillator a support and a light sensor. In other words: Every detector element comprises a scintillator, a support and at least one light sensor. Depending on the application, the device may designed with only one detector element as a hand tool, such as for use in a hospital or for example as a material- or personal contamination monitor comprising up to 100 or even more detector elements, to achieve an acceptable measurement time.

The device is provided in particular for detection of β-radiation and the scintillator is a β-scintillator. A material is classified as a β-scintillator, when it has a high efficiency with respect to incident β-radiation. The efficiency is therefore defined by the fraction of incident radiation, which results in the generation of photons, relative to the total incident radiation. A great number of photons is thus generated at high efficiency, when β-radiation impinges on the scintillator. A β-scintillator comprises an efficiency of at least 30%, preferably at least 60%, particularly preferably at least 90% with regard to a scintillator made of anthracene, which is used as a reference material, since this material has a particularly high efficiency and/or a very high luminous efficiency. As transparent β-scintillators, the scintillators described, for example in US 2014/0166889 A1 may be considered as well as other transparent polymers, plastic scintillators or crystal-scintillators. For detection of α-radiation or neutrons, scintillators based on zinc sulfide are used, for example. Since γ- and X-rays are produced by electrons energized by Compton scattering, the device or the detector element is also basically suited for the detection of γ- and X-rays. A thicker scintillator may be necessary at higher energies for the detection of γ- and X-rays than for β-radiation. The scintillator can then be made thicker and the support thinner, whereby in the extreme case only, a scintillator without support may be provided.

The first surface of the scintillator and the first surface of the support are optical interconnected, for example by an optically transmissive material. In a preferred embodiment, the scintillator and the support of a detector element have the same or a nearly identical refractive index, in order to prevent reflections to a large extent within the detector element. The formulation of the same or nearly identical refractive index is understood to mean, that the refractive index differs only to the extent that no optical interface results between the support and the scintillator, the scintillator and support then being optically interconnected without an optical separation layer. Scintillator and support are thus in optically conductive connection. The refractive index of the scintillator and of the support are considered to be the same or identical, if these differ from one another by a maximum of 10%, in particular by a maximum of 5% or even by a maximum of 2%. Use of the same refractive indices guarantees, that nearly all photons emitted by the scintillator enter the support and reach the light sensor. With use of an adhesive, the refractive index thereof is ideally exactly as large or nearly identical to the refractive index of the scintillator and of the support, in order to substantially prevent an optical separation layer, which results in a reflection or refraction of the radiation on the interface between support and scintillator and to enable as many photons as possible to enter the support.

Thereby, a detector element results in all, in which the propagation of the light or of the generated photons is determined essentially only by total reflection on the surface of the detector element, thus at the interface to the air. Within the detector element itself, reflections or refractions hardly take place. In other words: scintillator and support form a single total optical light conductor, so that the losses inside the detector element are minimized and the light occurs mainly at the active surface of the light sensor.

Other connection technology may also be used to optically join the scintillator and the support, which gives rise to no optical boundary layer, such as optically active fats. Direct welding or extrusion is particularly advantageous.

Further, it is an advantage when the support is an optical conductor with at least the attenuation length of the scintillator, thus more than 1 m.

The support or the light conductor thus has an attenuation length of less than 1 m, preferably 4 m or particularly preferably 10 m. The attenuation length is the length or pathway, at which the intensity of the light beam drops to the value 1/e, thus to about 37% at a wavelength of 425 nm. As support, in other words as light conductor, in particular a component made of plastic, for example poly(methyl methacrylate) (PMMA) or transparent polycarbonate (PC), or made of glass is used, whose refractive index is adjusted to the refractive index of the scintillator.

The focusing of the light onto the active surface of the light sensor and thus an increase of the detection sensitivity can be further enhanced, when a surface of the detector element is at least partially mirror-polished. The surface is thereby understood to be the total surface of a detector element, thus the second surface of the scintillator, the second surface of the support and the second surface of the scintillator and of the support, including the section of the side surface of the detector element on which the light sensor is disposed. In particular, the entire exposed surface of the detector element and an interface between detector element and air forming surface is completely mirror-polished. The entire exposed surface comprises all four side surfaces of the scintillator, all four side surfaces of the support and the second surface of the scintillator and the second surface of the support with exception of the area of the side surface of the detector element, in which the light sensor is disposed or is optically connected with the side surface of the detector element. Thereby, the light is totally reflected on the interface of detector element—air in a wide range of angles, thus for a large part of the incident angle. In the section of the side surface of the detector element, in which the light sensor is disposed, there is no such interface, so that the light thus mainly occurs only at the position of the light sensor and thus to a greater extent in the active surface of the light sensor, whereby the luminous efficiency is significantly increased. Reflections of the photons within the detector element or on surfaces thereof can be significantly improved by means of mirror-polished surfaces.

In order to allow only the entrance of ionizing α- and β-radiation into the scintillator, thus to prevent a troublesome incidence of external light into the detector element, the surface of the detector element may be vapor-treated completely with a layer made of reflecting material, in other words coated with metal, which nevertheless has a disadvantageous effect on the total reflections taking place on the surfaces. In particular with respect to the luminous efficiency of the detector element, it is therefore advantageous, to surround the detector element, and thus the scintillator, the support and the light sensor at least partially with a reflector. In other words, the detector element is at least partially disposed in one reflector or within a reflector or in a housing made of a reflective material functioning as a reflector. In particular, a reflector fixed on the back of the detector element, thus behind the second surface of the scintillator can further minimize light losses and thereby improve the properties of the detector element. By this means, the luminous efficiency and thus also the signal-noise ratio can be further improved, since the light is absorbed only on the active surface of the light sensor and otherwise, if the light, for example, was not yet reflected on the mirror-polished surface of the detector element, it reflects on the reflector and is returned into the support. Preferably an air space is present between the reflector and the surface of the detector element, in order to initially permit an undisturbed total reflection on the surface or on the interfaces of the detector element. The reflector and/or the inner housing surfaces consist, for example of aluminum, teflon or titanium oxide or are provided with a protective film. A mirror may also be used as a reflector. Thereby, every detector element may be surrounded by a separate reflector. For contamination monitors with multiple detector elements it is conceivable, to incorporate multiple, for example four detector elements in each case, in a common reflective housing.

On one of the first surfaces opposing the second surface of the scintillator, a film, for example a titanium film or an aluminized plastic film, may also be disposed with formation of an air space to the second surface, which permits an incidence of ionizing radiation on the scintillator, but at the same time prevents an incidence of interfering external light from the outside into the detector element.

In addition, at least one side surface of the detector element, can be surrounded by a reflector, for example a mirror, so that light which was not totally reflected on the surface or on the interface to the air and occurs from the detector element is reflected onto the mirror. The mirror is in turn preferably parallel and with formation of an air space, thus disposed at a distance from the side face of the detector element. Photons, whose incident angle on the first and second surface of the support meets, for example, the criteria for total reflection, are present on the side face, that is, a lateral surface perpendicular to the second surface which is not in the angle range for total reflection. The light occurring on the side faces of the detector element is then reflected into the detector element by means of the mirroring reflectors, so that the angle is not changed relative to the surfaces of the support. Thereby, the reflected light beam remains on the two opposing surfaces of the support in the angle range for total reflection.

Since the propagation of light within the detector element depends on loss-free total reflection, the light generated in the scintillation is almost completely captured by the light sensor, also when the surface of the light sensor is several orders of magnitude smaller than the surface of the detector element. Thereby, the detection sensitivity is also increased independent of the position of a scintillation event. It is virtually immaterial, whether the scintillation takes place immediately in front of the light sensor or on the opposing side of the detector element. Thereby, detectors will result having excellent homogeneity of response.

The light sensor is disposed on a side surface of the detector element, wherein it is advantageous when the side surface of the detector element is formed by the first side surface of the scintillator and by the first side surface of the support and the at least one light sensor is optically connected at least partially with the first side surface of the scintillator and at least partially with the first side surface of the support. The side surface of the detector element is thus a common side surface formed in part from a side surface of the support and in part by a side surface of the scintillator. Thereby, the incidence of photons into the light sensor and thus the luminous efficiency is increased.

The light sensor and the side surface of the detector element and/or the common side surface of the support and of the scintillator are likewise preferably optically connected with the side surface, for example also by an optically transmissive adhesive,

In a preferred development, the at least one sensor which is disposed on the first side surface of the scintillator and the first side surface of the support, extends from the second surface of the scintillator to the second surface of the support. In other words: the total thickness of scintillator and support corresponds to an edge length of the active or sensitive surface of the light sensor, which usually has a size of 6×6 mm or 3×3 mm. The total thickness of the detector element is thus just as large as a measured size of the light sensor, which is arranged on the side surface formed in common by the support and the scintillator.

The scintillator and the support of the detector element may comprise fundamentally different forms; for example, they may be rectangular or round in design. However, in each case it is advantageous, when the first surface of the scintillator and the first surface of the support, which are optically interconnected, are equal in size, so that the scintillator and support can be comprehensively and completely applied on top of each other and the luminous intensity is increased. The scintillator and the support are designed in particular as plates, so that the surfaces of the scintillator and the surfaces of the support are formed as flat sides or respectively, as even or flat surfaces. Both the scintillator and the support thus comprise in each case two opposing flat surfaces parallel to one another. The first flat surface of the scintillator, in other words the—relative to the angle of incidence of the radiation to be detected—rear flat side, and the first flat side of the support, thus the—relative to the angle of incidence of the radiation to be detected—front flat side, are planar in contact with one another and are joined optically planar.

Different sensors come into question as light sensors, for example photodetectors or semiconductor detectors. However, the at least one light sensor is preferably a silicon-photomultiplier (SiPM), which is adapted in spectral sensitivity to the emission spectrum of the scintillator. A silicon-photomultiplier makes possible a very compact and economical design of the detector element. Furthermore, in a device having multiple, adjacent detector elements, as is customary with contamination monitors, the dead zone and consequently the region in which the light sensor shows no sensitivity, is minimized. In particular for coincidence measurements, the detector elements are disposed as close as possible to one another. Due to the arrangement according to the invention of scintillator, support and light sensor or the respective design of the detector element, the detector element also having a silicon-photomultiplier also exhibits a good signal-noise ratio, comparable to conventional detectors having tube photomultipliers.

The scintillator comprises in particular a thickness of 0.1 to 2 mm, preferably 0.25 to 1 mm. With thickness lying within this range β-radiation from nuclear radiation is absorbed to a large extent, whereas γ-radiation interacts only slightly with the scintillator. As a result, the detection limit for radioactive radiation or contamination influencing gamma background is minimized. The support has a thickness of 2 to 8 mm, preferably of 5 to 6 mm. The thickness of the entire detector element is small in comparison the width and length thereof. The ratio of thickness to width and the ratio of thickness to length is in particular at least 1:10.

To evaluate the β-radiation detected by the light sensor, in particular the device has an evaluation unit.

A preferred embodiment of the device comprises at least two detector elements, which are disposed successively in direction of incidence of the radioactive radiation and are respectively disposed optically separated from one another. In other words: the device comprises multiple detector elements, which are successively arranged respectively in pairs, wherein the two respectively related detector elements are optically separated from one another. The optical separation can be effected, for example by a black plastic film or a thin metal film. Thereby, in particular silicon-photomultipliers are used as light sensors, so that a compact device results, which is advantageous in particular for hand tools. If acryl glass is used as support material, the support serves simultaneously as an impulse radiation absorber for β-radiation in addition to its function as light conductor

In order to maximize the absorption of the β-radiation in the support, it can be advantageous, to orient the respectively paired detector elements symmetric to the optical separation or respective light barrier. The two supports thus face each other and are only separated by the light barrier. Thereby, a sufficiently thick absorbent material is obtained, so the incidentβ-radiation does not reach the scintillator of the—relative to the direction of incidence—rear detector element.

The evaluation unit of the device is preferably further designed, such that a radioactive radiation impinging in both detector elements can be faded out. For example, in “fading out” the evaluation unit can cancel the signals in both detectors from such radiation and indicate no signal from it or separately determine radiation impinging on both detector elements from radiation impinging on just one detector element. For example, the evaluation unit is designed such that a measured value for different types of radiation, such as β-radiation and γ-radiation, can be determined by differentiation separately and independently of one other.

Such a device may be used in particular to detect β-radiation in γ-/β-fields, since the β-radiation occurs only in the detector element facing the receiving aperture of the radioactive radiation. However, γ-radiation penetrates the light barrier and the support and/or light conductor of both detector elements and occurs in both detector elements, and thus can be registered both with the light sensor of the front—relative to the direction of incidence—and also with the light sensor of the rear detector element. In other words: γ-radiation produces a light flash in the scintillator of the front detector element and also in the scintillator of the rear detector elements. Undesired γ-radiation as well as cosmic radiation can be faded out by a coincidence circuit. Such an arrangement thus makes possible very good contamination detection limits at high γ-background and a separate reading of γ- and β-radiation. The support of the detector element also functions simultaneously as β-radiation screening for the rear detector element.

The second-mentioned objective is achieved by features according to claim 18. To detect radioactive radiation with a device as described above, photons emitted by the scintillator are conducted to the at least one light sensor by the support and converted into a signal. In the course of this, a radio-active radiation and/or a radiation event in particular is then only registered, when at least two light sensors essentially generate a light signal at the same time. Only in the case of a coincidence of signals, or respectively of photons impinging on the light sensor in at least two light sensors is an output signal generated, which indicates a radioactive contamination. An evaluation unit is provided for this, for example, which processes the electrical signals produced by the light sensor and outputs as measured values. This measured value and/or the output signal can be utilized to indicate an alarm signal. The radioactive radiation to be detected is particularly β-radiation and/or α-radiation.

The invention is more precisely explained hereinafter with regard to further details and advantages based on the description of embodiments and with reference to the appended drawings. In a schematic diagram in each case:

FIG. 1 depicts a device for detection of radioactive radiation in a perspective view,

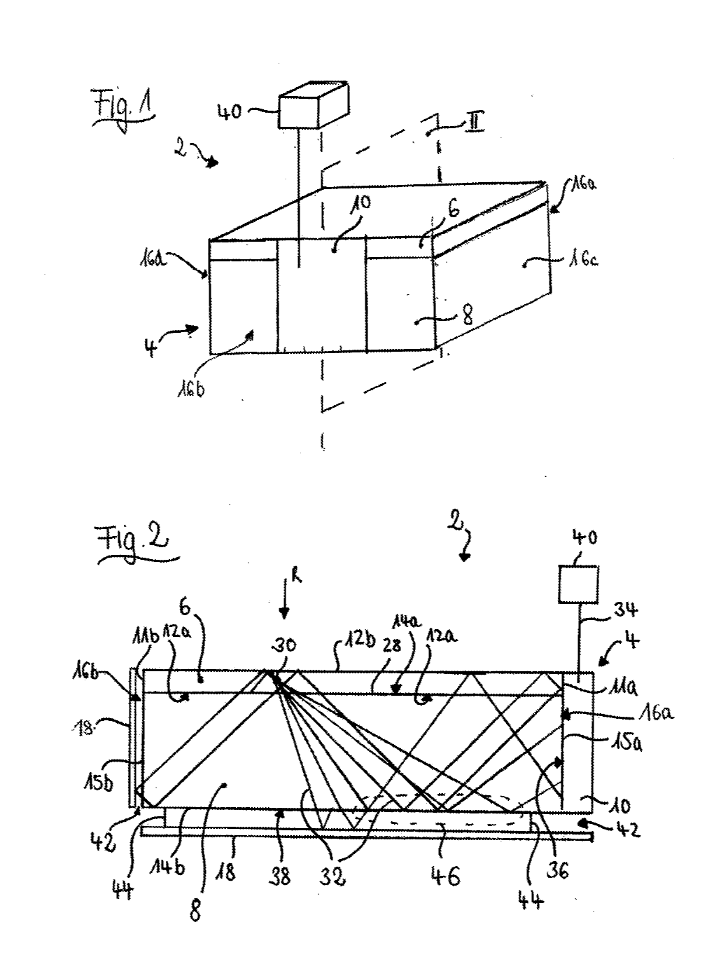

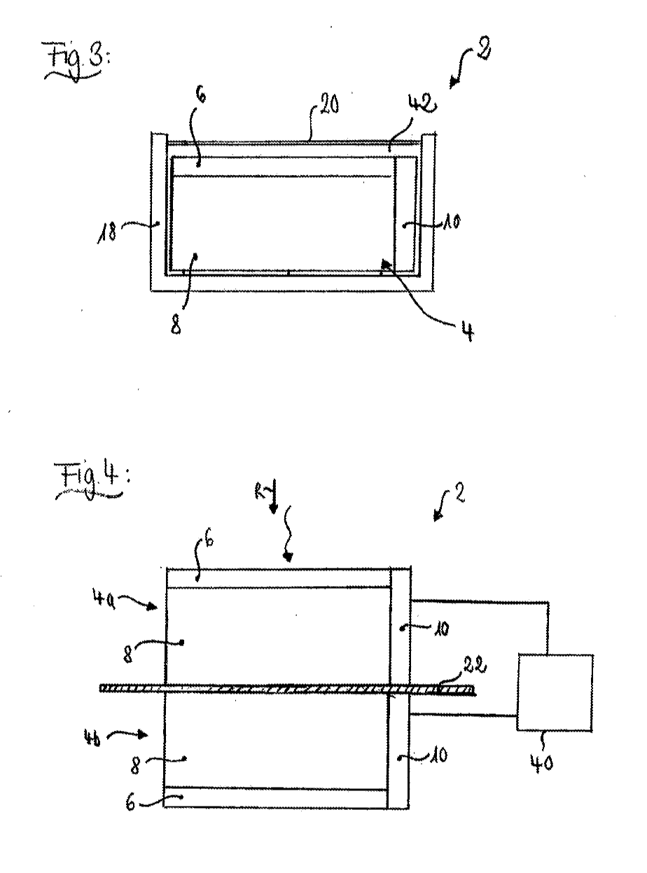

FIG. 2 depicts a device according to FIG. 1 along the intersecting plane II, wherein the detector element is partly surrounded by a reflector.

FIG. 3 depicts a device with a reflector,

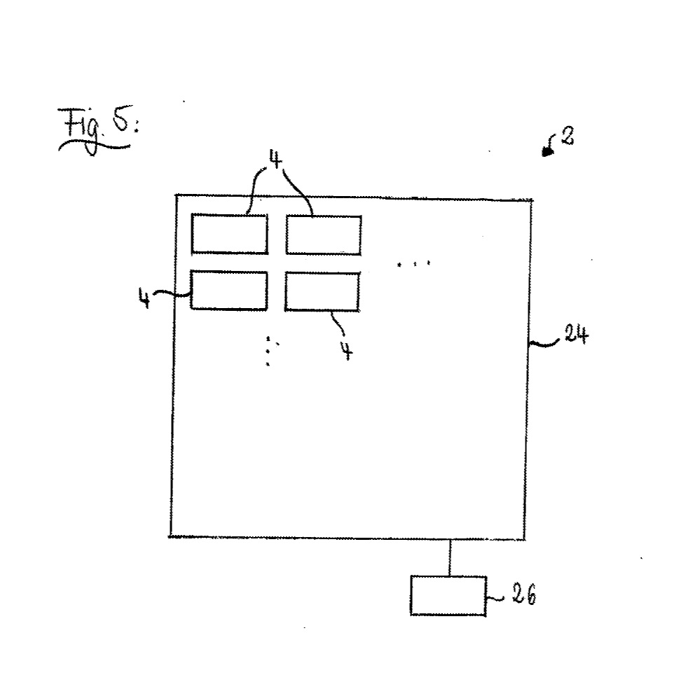

FIG. 4 depicts a device with two—relative to the direction of incidence—detector elements arranged in a row,

FIG. 5 depicts a device with multiple detector elements for detection of radioactive radiation.

FIG. 1 depicts a device 2 for detection of radioactive radiation or contamination, in particular for use to measure α- and β-radiation, having a detector element 4. The detector element 4 comprises a scintillator 6, a support 8 and a light sensor 10.

The scintillator 6 basically consists of a material, which is transparent for photons generated in scintillator 6. In addition, scintillator 6 is a β-scintillator, which has a high efficiency with respect to the incident β-radiation, so that a large number of photons is generated. It is configured in the form of a plate approximately 0.5 mm thick. The support 8 likewise consists of a material, which is transparent for the photons generated in scintillator 6, and thus is made of a material such as PMMA, PC, polystyrene or glass that is highly conductive for the wavelength of the photons emitted by the scintillator 6. Support 8 has at least the transparency and/or attenuation length of the scintillator. It is particularly advantageous, when the support 8 has a higher transparency and/or attenuation length. The scintillator 6 and the support 8 have nearly identical refraction indices. Support 8 is likewise designed as a plate with thickness of approximately 5 mm.

As shown in FIG. 2, the scintillator 6 comprises a first surface 12a and a second surface 12b opposite to the first surface 12a and extending parallel to it, which respectively are designed as flat sides 12a, 12b. The support 8 likewise comprises a first surface 14a designed as a flat side and a second surface 14b designed as a flat side, which is opposite to the first surface 14a and extends parallel to it. In detector element 3, the first flat side 12a of the scintillator 6 is optically connected to the first flat side 14a of the support 8 by means of an optically transmissive scintillator-support-connection 28, wherein the two components can also be connected with each other either directly or indirectly via an optically transmissive adhesive. In order to obtain a high light output, the first flat side 12a of the scintillator 6 and the first flat side 14a of the support 8 are equal in size and are optically connected with one another over the entire area.

The light sensor 10 is a silicon-photomultiplier and is disposed on a side face 16a of the detector element 4 formed by the side face 15a of the support 8 and by the side face 11a of the scintillator 6 and is optically connected with side face 16a. The edge length of the active surface 36 of the light sensor 10 corresponds to a total thickness of the support 8 and the scintillator 6. The light sensor 10 thus extends relative to the incidence direction R completely from the second surface 12b of the scintillator 6 towards the second surface 14b of the support 8.

The exposed surface of the detector element 4, thus the second flat side 12b of the scintillator 8, the second flat side 14b of the support 6 and the side faces 11b, c, d of the scintillator 6 and the side faces 15b, c, d of support 8 and also the areas of side face 16a of detector element 4 or the side face 11a of scintillator 6 and side face 15a of support 8 which are not optically coupled with light sensor 10, are mirror-polished. If ionizing radiation, α- or β-radiation, impinges on scintillator 6, then light flashes are generated therein and/or photons are emitted, which leave behind the α- or β-radiation and an ionization trace and thereby a light trace in the scintillator 6. The photons 30 are conducted by the scintillator 6 and the support 8 along the path 32 to the light sensor 10. The mirror-polished surface ensures that a total reflection takes place on the interfaces 38, which prevents an occurrence of photons 30. After a great number of reflections, the photons are finally absorbed on the surface of the light sensor 10. In the active area 36 of the light sensor 10, photons 30 are converted into an electrical signal, out of which signal β- and γ-contamination values are derived according to conventional radiation measurement techniques.

A reflector 18 is disposed on the back of detector element 4 and/or behind the second flat side 14b of the support 8 parallel thereto, forming a air space 42. For this purpose, the detector element 4 is supported on only a few support points 44 in the form of minimal punctiform mounts facing the reflector. A reflector 18 designed as a reflecting mirror is provided on the side surface 16b of the detector element 4 opposite to the light sensor 10 and advantageously also on the three other side surfaces 16a, 16c, 16d, the reflector being parallel to side surface 16b. Photons 30 and/or a light beam, which was not totally reflected on an interface, are reflected onto the reflector 18 and reenter the support 8 and/or the light conductor. Thereby, the light output of the detector element is raised, because photons 30, which enter the support 8 again on the side surface 16b and/or also on the three other side surfaces 16a, 16b, 16d are not in the angular spread for total reflection and remain further on the second flat side 12b of the scintillator 6 and the second flat side 14b of support 8 in the angular spread for total reflection. In region 46 exemplary propagation paths 32 with total reflection on the interface to air are shown.

In an embodiment shown in FIG. 3, the detector element 4 is disposed in a reflector 18 and/or in a housing, the inner housing surfaces of which consist of a reflective material. The detector element is arranged in the reflector 18, such that the underside thereof, and thus the second flat surface 14b of the support 8 and side surfaces 16a, b, c, d thereof, are surrounded by the reflector 18. Thereby, an air space 42 may again be configured between the detector element 4 and the reflector. On the top side of the detector element 4, the reflector 18 protrudes over the second flat side 12b of the scintillator 6. The second flat side 12b of scintillator 6 is covered by α- and β-radiation transmissive, light-proof film 20 made of aluminized plastic with formation of an air space 42, which completely encloses the detector element 4 together with the reflector 18.

In FIG. 4 a device is shown, which consists of two detector elements 4a, 4b, which—relative to the incidence direction R of the radioactive radiation—are arranged in a row. The two detector elements 4a, 4b are optically separated from one another by a light barrier 22, for example an aluminum foil, in order to detect β- and γ-radiation separately from each other. The β-radiation is completely absorbed in the supports 8 and light barrier 22. The photons generated by β- and γ-radiation in the front detector element 4a cannot overcome the light barrier 22 and are thus registered only in the front detector element 4a. However, γ-radiation and cosmic radiation penetrate the support 8 without substantial loss and are detected equally in both detector elements 4a, 4b. By fading out the coincident signals with an evaluation unit 40, the interfering background due to cosmic radiation (muons) can be masked and the detection range for β-contamination improved. By subtracting the detected events and/or the measured impulse rates from one another by means of the evaluation unit 40, measured values for pure β- and γ-radiation are derived.

FIG. 5 shows a device 2, which can be used in whole body monitors 24 and comprises multiple detector elements 4. The individual detector elements 4 are connected with an evaluation unit 26, which can perform an evaluation of separate signals 34 generated by the respective light sensors 10 of the detector element 4 using methods conventional in nuclear radiation technology.

If device 2 operates to detect a radioactive radiation, a photon 30 emitted from the scintillator 6 is conducted by the support 8 to the light sensor 10 and converted there into a signal 34. If a detector element 4 comprises 2 light sensors 10 (not shown), a radioactive radiation or a radioactive contamination is not indicated, when the two light sensors 10 generate a signal 34 at the same time. The reading of the radioactive radiation takes place, for example by the evaluation unit 26, which produces an output signal only in the case of coincidence of two signals 34.

### LIST OF REFERENCE SIGNS

2 device
4 detector element
6 scintillator
8 support
10 light sensor
11a, b, c, d side surfaces of the scintillator
12a first flat side of the scintillator
12b second flat side of the scintillator
14a first flat side of the support
14b second flat side of the support
15a, b, c, d side surfaces of the support
16a, b, c, d side surfaces of the detector element
18 reflector
20 film
22 light barrier
24 monitor
26 evaluation unit
28 adhesive
30 photon
32 path
34 signal
36 active surface of the light sensor
38 interface
40 evaluation unit
42 air space
44 support point
46 region

1. A device for detection of radioactive radiation having at least one detector element comprising
a scintillator made of material transmissive for photons emitted by the scintillator, which comprises a first surface and a second surface opposite to the first surface, which extends respectively from a first side surface of the scintillator to a second side surface of the scintillator opposite to the first side surface,
a support made of a material transmissive for photons emitted by the scintillator, which comprises a first surface and a second surface opposite to the first surface, which extends respectively from a first side surface of the support to a second side surface of the support opposite to the first side surface, wherein the first surface of the support is optically connected with the first surface of the scintillator, and
at least one light sensor, which is disposed on an inner side surface of the detector element and is optically connected with the first side surface of the scintillator and/or the first side surface of the support.

2. A device according to claim 1, wherein the device is provided for detection of β-radiation and the scintillator is a β-scintillator.

3. A device according to claim 1, wherein the scintillator and the support have the same refractive index.

4. A device according to claim 1, wherein the support comprises an attenuation length as light conductor, which at least corresponds to an attenuation length of the scintillator.

5. A device according to claim 1, in which a surface of the detector element is at least partially mirror-polished.

6. A device according to claim 1, in which the at least one detector element is surrounded at least in part by a reflector.

7. A device according to claim 1, in which the side surface of the detector element is formed by the first side surface of the scintillator and by the first side surface of the support and the at least one light sensor is optically connected at least partly with the first side surface of the scintillator and at least partly with the first side surface of the support.

8. A device according to claim 7, wherein the at least one light sensor, which is disposed on the first side surface of the scintillator and on the first side surface of the support, extends from the second surface of the scintillator to the second surface of the support.

9. A device according to claim 1, comprising at least one detector element, in which the first surface of the scintillator and the first surface of the support are equal in size.

10. A device according to claim 1, wherein the scintillator and the support are designed as plates, so that the surfaces of the scintillator and the surfaces of the support are designed as flat sides.

11. A device according to claim 1, in which the at least one light sensor is a photomultiplier.

12. A device according to claim 1, in which the scintillator has a thickness of 0.1 to 2 mm, preferably of 0.25 to 1 mm.

13. A device according to claim 1, in which the support has a thickness of 2 to 8 mm, preferably of 5 to 6 mm.

14. A device according to claim 1, comprising an evaluation unit for evaluation of the β-radiation detected by the light sensor.

15. A device according to claim 1, comprising at least two detector elements, which are arranged in the incidence of the radioactive radiation in a row and respectively are optically separated from one another.

16. A device according to claim 15, comprising an evaluation unit, which is designed such that a radiation occurring in both detector elements can be faded out.

17. A device according to claim 15, comprising an evaluation unit, which is designed such that a measured value for β-radiation and a measured value for γ-radiation are detectable separately from each other.

18. A method for detection of radioactive radiation with a device according to claim 1, in which photons emitted by the scintillator are conducted by the scintillator and/or support to the light sensor and are converted into a signal.

19. A method according to claim 18, in which a radioactive radiation is registered, when at least two light sensors substantially generate a signal at the same time.

20. A method according to claim 18, wherein the radioactive radiation is β-radiation.

21. A method according to claim 18, wherein the radioactive radiation is α-radiation.
